(19) United States
(12) Patent Application Publication
(10) Pub. No.: US 2008/0212785 A1
(43) Pub. Date: Sep. 4, 2008

(54) Appliance for Converting Digital Audio Broadcast (Dab) Signals

(75) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,065

(22) PCT Filed: Feb. 21, 2005
(86) PCT No.: PCT/IB05/50628

§ 371 Date: Aug. 17, 2006

(30) Foreign Application Priority Data
Feb. 24, 2004 (EP) 04100720.4

(51) Int. Cl. H04H 20/47

(52) U.S. Cl. 381/2

(57) ABSTRACT

The invention relates to an appliance (1) for converting DAB signals into FM signals and for transmitting the FM signals to an FM receiver (2), with a DAB receiver (3), which is equipped with an antenna input (4) and, at an output (10), emits an audio signal derived from a received DAB signal, and with an FM modulator unit (13) for generating an FM signal modulated with the audio signal, and a transmission unit for transmitting the FM signal to the FM receiver (2), and with a control stage (21), wherein the transmission unit is equipped with wired connection means (16), to which wired connection means (16) frequency detection means (20) are connected, which are connected to the control means (21) and arranged to detect the high frequency set in the FM receiver (2), and to generate a result signal representing the detection result and deliver it to the control stage (21) for channel setting purposes, and wherein the control stage (21) is connected to a channel-setting input (29) of the DAB receiver (3) in order to tune the DAB receiver (3) on the basis of the result signal.

### FIELD OF THE INVENTION

The invention relates to an appliance for converting DAB signals into FM signals and for transmitting the FM signals to an FM receiver with DAB reception means, which DAB reception means are equipped with an antenna input and, at an output, emit an audio signal derived from a received DAB signal, and with FM modulator means for generating an FM signal modulated with the audio signal, and with transmission means for transmitting the FM signal to the FM receiver, and with control means.

### BACKGROUND OF THE INVENTION

An appliance of this kind is known from document U.S. Pat. No. 6,493,546 B2. With this known appliance, what is involved is the conversion of an audio signal originating from an auxiliary source into the FM (Frequency Modulation) band, and sending it via a wireless link or transmission to a radio device, i.e. an FM receiver. Serving as the auxiliary source may be, for example, a satellite broadcast receiver, in particular a DAB (Digital Audio Broadcasting) receiver or a CD player or tape cassette player. For the wireless transmission to the radio device, suitable frequencies that are momentarily free and can be used for radio transmission to the FM receiver are sought via a scanning receiver with separate antenna. A free carrier frequency traced in this manner is indicated to the user via a display, and the user then has to tune precisely this free carrier frequency on the FM receiver. As a result, this known appliance is complicated to operate; it is also disadvantageous to the extent that a carrier frequency that has been found and selected will not necessarily remain free pending the tuning of the appliance, i.e. the FM modulator means in the appliance, so it is often necessary to look for another free frequency. Furthermore, in view of the searching for free frequencies and the associated quality evaluation, the amount of circuitry involved in this appliance is relatively great, quite apart from the fact that an additional display and dedicated inputting components are also necessary on the appliance. In addition, this known appliance represents a device that has to be accessible for an own operation. The known appliance is intended, in particular, for applications in motor vehicles, and its application in stationary domestic systems, i.e. hi-fi stereo systems and the like, which are frequently costly, would appear to make little sense, owing to the alternative options that are available for these systems.

On the other hand, considerable efforts in relation to a market launch have been made recently in the field of digital audio broadcasting (DAB). The DAB system undoubtedly offers numerous technical advantages as compared with the conventional FM receivers, e.g. in radio devices or as FM tuner devices etc., so that it may be anticipated that the DAB system will, in the near future, be introduced with full geographical coverage, and this will take place within a comparatively short period. However, this would mean that, following the introduction of this DAB system, a large number of conventional FM receivers would suddenly become useless, since FM radio signals would no longer be transmitted, and the existing FM receivers would be replaced with DAB appliances. Quite apart from the enormous environmental pollution caused by the disposal of the existing FM receivers, high costs for consumers would be involved as a result of the procurement of the new DAB appliances, which is all the more significant when the static domestic audio systems, which are costly per se, are taken into account. By contrast, a changeover to the new digital radio standard for radios in motor vehicles is easier to accomplish, since appliances that are less costly are generally involved here. One further aspect that induces consumers to hold on to an existing radio receiver is the fact that, in the case of matching components (such as a tuner, preamplifier, output amplifier, cassette deck, CD player etc.) in existing domestic systems, exchanging a tuner component for a different one, which would then no longer match the remaining components for aesthetic or visual reasons, is not undertaken willingly.

### OBJECT AND SUMMARY OF THE INVENTION

It is an object of the invention to remedy this situation and to provide an appliance of the type specified above that enables the consumer to retain existing audio systems, including those with FM tuners, even if a switch from conventional FM radio systems to the new DAB system is undertaken.

A particular object that can be stated is to make available an appliance as specified above as a supplementary device, which, once it has been procured and installed, is then of no further concern to the user, since it assumes and implements all the necessary functions, in particular automatically assuming and implementing the consumer's wishes in searching for transmission channels in order that, during tuning to a particular FM transmission channel, a suitable DAB channel that corresponds to the FM transmission channel is automatically selected and its useful signals are supplied to the FM receiver.

In accordance with a further object of the invention, the appliance is to be of a simple, economical design and, in particular, to be easy to operate for the first-time setting, wherein any subsequent operation will preferably be unnecessary in the normal case.

A further object comprises designing an appliance as specified above in such a way that, in the event of the transmission of conventional FM signals, the reception and switching-through of an FM channel of this kind to the FM receiver is possible.

In accordance with a main aspect of the invention, features in accordance with the invention are provided in an appliance in accordance with the invention, so that an appliance in accordance with the invention may be characterized in the following manner:

Appliance for converting DAB signals into FM signals and for transmitting the FM signals to an FM receiver, with DAB reception means, which DAB reception means are equipped with an antenna input and, at an output, emit an audio signal derived from a received DAB signal, and with FM modulator means for generating an FM signal modulated with the audio signal, and with transmission means for transmitting the FM signal to the FM receiver, and with control means, wherein the transmission means are equipped with wired connection means, to which wired connection means frequency detection means are connected, which frequency detection means are connected to the control means and arranged to detect the high frequency set in the FM receiver, and to generate a result signal representing the detection result and deliver it to the control means, and wherein the control means are connected to a channel-setting input of the DAB reception means, and wherein the DAB reception means are designed to be tuned on the basis of the result signal delivered to their channel-setting input.

With the present appliance, also referred to below as a DAB/FM converter, a desired channel set by a user at the FM receiver is identified on the basis of the local oscillator frequency (which is known to differ by 10.7 MHz—the intermediate frequency—from the transmission frequency) generated in the FM receiver in accordance with the set reception frequency. An identification or detection of the local oscillator frequency in this manner via the wired connection means on the basis of the leakage signals (residues) transmitted via these wired connection means is readily possible. The frequency detection means used hereby may be designed in a manner that is conventional per se. A comparatively complex embodiment for this is described in, for example, document U.S. Pat. No. 4,723,302 A, wherein the aim is to establish which FM channel an FM receiver is currently receiving. The frequency detection means are, however, preferably realized with the aid of an auxiliary FM receiver, which is known per se, for example using a single-chip tuner module available on the market, designated TEA 5777, from Philips Semiconductors. This auxiliary FM receiver has a rapid transmitter scanning function and can in this way find the local oscillator frequency rapidly and can lock onto it using a phase-locked loop (PLL circuit). The reception frequency range can be adjusted for a frequency band in the range from 98.20 MHz to 118.70 MHz (if, in accordance with the given standard, the local oscillator frequency lies at the value of the intermediate frequency of 10.7 MHz above the transmission frequency, wherein the transmission frequency lies in the FM band between 87.50 MHz and 108.00 MHz worldwide) or for a frequency band in the range from 63.30 MHz to 79.30 MHz (in the case of the Japanese standard, where the local oscillator frequency lies at the value of the intermediate frequency of 10.7 MHz below the transmission frequency).

In order to reduce noise and interference effects arising from intermodulation products, filter means, in particular passive bandpass filter means, may be arranged upstream of the frequency detection means, wherein a passband may be set up in accordance with the reception frequency range of the frequency detection means as specified above. In this manner, the frequency detection means are able to undertake an especially rapid frequency detection, especially if they are equipped with an auxiliary FM receiver, owing to the comparatively “clean” HF signal supplied.

The wired connection means preferably comprise a coaxial connection to the antenna jack on the FM receiver, wherein a corresponding coaxial-antenna output jack may be provided, to which the FM signal obtained by the conversion is applied.

The DAB/FM converter, i.e. the appliance under discussion here, can also be embodied without inputting means, or with only a few, as well as without indication means, such as LEDs or a display, or with only a few, and, in practice, the appliance may be simply connected between an antenna and the FM receiver, adjusted once, and then be subject to no further operation, so that all the user need concern himself with are the existing components of his system, with which he is already familiar, whereas the DAB/FM converter can be installed so as to be invisible.

In order to undertake the conversion in an especially efficient manner, memory means for storing information concerning the mutual correspondence or concordance of DAB channels and FM channels may be assigned to the control means. When, in operation, the control means obtain from the frequency detection means the appropriate information about the FM channel set, i.e. the one required by the user, they activate the DAB reception means accordingly, on the basis of the stored concordance information, via their channel-setting input, so that tuning to the associated DAB channel takes place there. Once the DAB channel has been set on the DAB reception means, the decoding of a—digital—audio signal from the DAB reception signal takes place in a conventional manner, wherein this digital audio signal is then supplied, via digital/analog conversion means, to an analog-audio signal input of the FM modulator means, in order that it can then be modulated upon the relevant carrier frequency. The FM modulator means may also be set up to process supplementary information during the FM modulation. In particular, provision is hereby made for coded RDS (Radio Data System known in the USA as RDBS system) information to be processed in a manner that is conventional per se and shown on a display (if present) on the FM receiver in a conventional manner. Accordingly, a composite output signal can be obtained, which contains both audio information and text information. An FM channel reception is thereby “emulated” via the DAB/FM converter, although in actual fact a DAB channel is received. By way of addition, any other information possible in the DAB system, such as time information or “radiotext” information may, of course, be coded and transmitted to the FM receiver for visual reproduction.

In order that the different setting operations on the existing FM receiver can be recognized in a suitable manner, e.g. whether an automatic transmitter search has been started or whether manual tuning is being undertaken, leading to different patterns in the frequency tuning, it is also useful if the frequency detection means are set up, together with the control means, to recognize high-frequency change patterns in order that manual or automatic transmitter scanning operations undertaken at the FM receiver can be recognized. It is hereby especially advantageous if a high-frequency deviation acceptance window is defined in the frequency detection means. This acceptance window corresponds to a predetermined HF bandwidth and, as soon as there is a departure from this acceptance window, at around ±20 kHz either side of the particular carrier frequency, the frequency detection means start a new frequency detection operation, depending on the recognized change pattern. If, as a result of the pattern, a rapid transmission search is recognized in the FM receiver, this frequency detection operation can then lead to a corresponding automatic transmitter search in the DAB reception means. If, however, manual tuning is recognized (owing to the slow changes to the oscillator frequency), then, working step-wise in the correct scanning direction, the nearest particular DAB channel frequency will be set. The “nearest” DAB frequency should not necessarily be taken to mean the frequency that is adjacent in the DAB band; rather, it may be the associated DAB frequency found using the information stored in the memory means, which may well correspond to a DAB channel that is located farther away.

In the event that FM channels are transmitted despite the insertion of the DAB/FM converter, in order to enable the reception of these FM channels in the conventional manner, the wired connection means in the present appliance may be connected to the antenna input of the DAB reception means via a bypass line, wherein switching means that can be actuated in this bypass line are provided for either through-connection or to interrupt the signal transmission on this line. These switching means may, for example, be connected to the control means with a control input, in order that an automatic change from DAB reception to FM reception can take place or that a change of this kind can be initiated via inputting means or actuation means.

Associated with the control means may be inputting means, such as, in particular, a remote-control device to enable a first setting, in particular with the storage of information concerning assignment of DAB channels and FM channels. The device may hereby be equipped with its own reception component for this remote control, in particular an infrared receiver. It is also conceivable for a connection line to remote-control means of the existing FM receiver to be provided and, via its remote-control device, to undertake corresponding entries at the control means of the DAB/FM converter.

One further advantageous option comprises the provision, in cases of need, of the analog audio signal derived from the DAB reception means directly to output connections, such as CINCH connectors.

Overall, of particular advantage with the present appliance is the fact that it can be installed “in the background” and can operate in the background, so it does not impair the appearance of an existing system, quite apart from the fact that the existing system can be retained as such, without any technical modifications. Accordingly, all the functions of the existing system with which the user is familiar are retained, wherein, however, additional functions are enabled owing to the services offered in the DAB system. The appliance may take the form of a single basic embodiment for the most diverse kinds of FM receivers, i.e. no special adaptations whatever are required for the most varied appliance types in the case of FM radio appliances.

### BRIEF DESCRIPTION OF THE DRAWINGS

The invention will be further described with reference to examples of embodiments shown in the drawings, to which, however, the invention is not restricted.

FIG. 1 shows, schematically in the form of a block circuit diagram, an appliance in accordance with the invention for converting DAB signals into FM signals and for transmitting these FM signals to an FM receiver, which is conventional per se and which, for the sake of completeness, is also shown quite schematically.

FIG. 2 shows, in a flowchart, the procedure for a manual tuning and transmitter search and for undertaking station presettings.

FIG. 3 shows, in a similar flowchart, the procedure for a presetting of new DAB stations in association with FM channels of an FM receiver.

FIG. 4 shows, in a part of a flowchart, an alternative option for starting a station setting procedure, e.g. in the event of overwriting a transmitter that has previously been set and stored.

### DESCRIPTION OF EMBODIMENTS

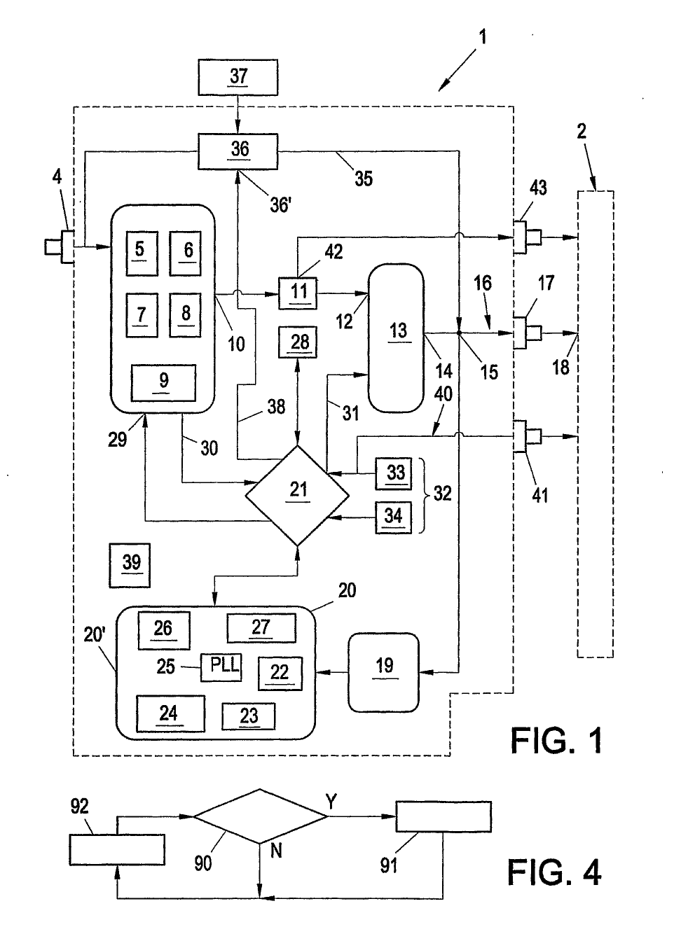

FIG. 1 shows, schematically, an appliance 1 for converting DAB signals into FM signals and for transmitting these FM signals to an FM receiver 2. In accordance with FIG. 1, the appliance 1 is equipped with DAB reception means 3 that are conventional per se, and are connected to an antenna (not shown) via an antenna input jack 4. As usual per se, the DAB reception means 3 are equipped with an input stage 5 and with an FFT, demultiplexer and channel-decoder module 6 (FFT=Fast Fourier Transformation) and with a deinterleaver, FIC-decoder and PAD-decoder module 7 (FIC=Fast Information Channel, PAD=Program Associated Data) and with an audio decoder 8 and with a serial interface 9. At an output 10, the DAB reception means 3 contained in the appliance 1 emit a digital audio signal, which digital audio signal is supplied to a D/A converter 11 for the purpose of generating an analog audio signal. The appliance 1 is further equipped with FM modulator means 13, which FM modulator means 13 are designed to generate stereo FM signals, including the coding of RDS information in a manner that is conventional per se. The analog audio signal is sent to an audio input 12 of the FM modulator means 13. The FM modulator means 13 hereby comprise a carrier-frequency oscillator (not shown), which generates an HF carrier, to which HF carrier the low-frequency useful signals, i.e. the analog audio signal, are modulated. The composite, or modulated, signal emitted at an output 14 of the FM modulator means 13 is supplied, via a connection point 15, or via wired connection means 16, including an antenna-output jack 17, to an input 18 of the FM receiver 2.

In the present case, the connection means 16 are realized by coaxial cables.

Also contained in the appliance 1 are frequency detection means 20, which frequency detection means 20 are connected, via bandpass filter means 19, to the connection point 15, and which frequency detection means 20 will be described in greater detail below.

The FM receiver 2 may be an own tuner component of a stereo system, e.g. a mini/midi or micro system, or it may be part of a combined receiver/amplifier component or of another combined radio appliance. What is important here is that the particular local oscillator frequencies (LOF) set in the FM receiver 2 can be ascertained, via the wired connection means 16, at the connection point 15 in the form of HF leakage signals. These local oscillator frequencies are supplied, via the bandpass filter means 19, to the frequency detection means 20. In the frequency detection means 20, the particular filtered HF leakage signal is recognized in terms of its frequency, and a result signal representing the detection result is generated, which result signal comprises information concerning the frequency—thereby concerning the local oscillator frequency (LOF) set at the FM receiver 2—and concerning the signal strength and any frequency deviations. The result signal is delivered from the frequency detection means 20 to the control means 21 connected to them.

In the present case, the frequency detection means 20 include an auxiliary FM receiver 20′ with a phase-locked loop 25 (PLL circuit), but may also take the form of a circuit that is conventional per se. In the present embodiment, the frequency detection means 20 are equipped with an input stage 22, a mixer stage 23, a local frequency oscillator 24, the already-mentioned PLL circuit 25, a control logic 26 and, finally, a frequency counter and interface module 27. The frequency detection means 20 may hereby be realized by, in particular, a conventional tuner module, such as the tuner module available under the designation TEA 5777 from Philips Semiconductors, and, in the course of the frequency detection, a locking onto the frequency of the received filtered HF leakage signal takes place, i.e. the local frequency oscillator 24 is tuned to this frequency. The frequency detection means 20 detect and monitor the local oscillator frequency of the FM receiver 2 in this manner. As mentioned, this local oscillator frequency of the FM receiver 2 generally lies in the frequency range of the upper intermediate frequency, i.e. 10.7 MHz, above the particular channel frequency set. The exception here is the case of Japan, where the local oscillator frequency lies below the FM channel frequency by the intermediate frequency of 10.7 MHz. Since the leakage signals of the local oscillator frequency have only a low signal strength, it is useful if the frequency detection means 20 exhibit a special sensitivity towards this particular frequency band in order that the separation from other high-frequency signals can be carried out, in an efficient manner. As described, the embodiment with the FM auxiliary receiver 20′ is especially suitable for this purpose. Likewise, the supplying of the HF leakage signal via the bandpass filter means 19, which are tuned to a corresponding frequency band, is advantageous for this reason. Accordingly, for the standard existing outside Japan, the bandpass filter means 19 and the auxiliary FM receiver 20′, i.e. the frequency detection means 20 in general, can be rated for a frequency range from 98.20 MHz to 118.70 MHz. For Japan, the FM range may be set at 63.30 MHz to 79.30 MHz in order to take into account the frequency band for the local oscillator frequencies from 74.00 MHz to 90.00 MHz.

The control means 21 take the form of a microprocessor. Assigned to the control means 21 are memory means 28, in which memory means 28 concordance information concerning the assignment of DAB channels to FM channels is stored in tabular form. On recognizing a particular local oscillator frequency, the control means 21 can ascertain an associated DAB channel on the basis of this concordance information or tables, and, via a channel-setting input 29 of the DAB reception means 3, the control means 21 then activate these DAB reception means 3 to tune to the desired DAB channel. In addition, other control data, not explained in greater detail here, can also be transmitted via this connection to the DAB reception means.

Conversely, special data, such as the already-mentioned FIC data and PAD data, may be supplied to the control means 21 from the DAB reception means 3 via a data line 30. The control means 21 in turn supply corresponding control data and output data, via a connection 31, to the FM modulator means 13 for the generation of the HF carrier with the desired frequency and for modulation or coding purposes, wherein the data, as well as the audio signal, is included in the composite signal transmitted via the wired connection means 16 to the FM receiver 2. In the FM receiver 2, the signals and data are demodulated, or decoded, wherein the data can be shown via e.g. a display present there. Since the technology used in the FM receiver 2 is a conventional one per se—compare the RDS system, for example—no further explanation is required here.

Finally, inputting means 32, such as, in particular, remote-control means with an IR receiver 33, and any other inputting means 34, in particular a keypad, may be associated with the control means 21.

In addition, a connection line or bypass line 35 leading from the antenna-input jack 4 to the output jack 17 with included switching means 36 is present in the embodiment example shown, in order that, in the event of transmitted FM radio signals, the FM signals can be switched through to the FM receiver 2 via this line 35 and the connection means 16. Assigned to the switching means 36 may be a manual actuation element 37. In addition to, or instead of, this, the switching means 36 with a control input 36′ may be connected via a switching line 38 to the control means 21 in order that an automatic or manual actuation of the switching means 36 can be initiated either when an entry to this effect is input via the inputting means 32 or when there is an automatic recognition of an FM channel reception, e.g. via the data line 30.

Albeit that the present appliance 1 preferably does without, and is designed without, any further inputting elements or display elements, visual and/or acoustic indication elements, such as LEDs, displays or loudspeakers to indicate or reproduce status information etc. may be installed if appropriate, as shown schematically with display means 39 as a general example within the appliance 1 in FIG. 1.

Apart from the remote-control means 33 shown (infrared receiver), the inputting means 32 may comprise, in particular, keys, rotary adjusters or similar as the inputting means 34. Moreover, in addition to, or instead of, the remote-control means 33, a connection 40 may be provided via a connection socket 41 to a conventional remote-control component present in the FM receiver 2 with an IR receiver, in order to transmit remote-control commands for the appliance 1 via the better accessible FM receiver 2, e.g. via infrared signals.

Finally, also shown in FIG. 1 is the fact that, from the D/A converter 11, an output 42 carrying the analog audio signal can be routed directly to an output socket 43 in order that, if desired, the audio signal can be taken from this socket (in practice multiple sockets, such as CINCH sockets, in the case of stereo signals) and supplied to loudspeakers.

In operation, in the preferred embodiment, the frequency detection means 20 operate as auxiliary FM receivers 20′ according to the method of a rapid transmitter search. The auxiliary FM receiver 20′ is hereby initially set to a particular sensitivity threshold, and a maximum deviation from the particular high frequency by +20 kHz is specified so that a corresponding “acceptance window” is defined. It should be mentioned here that the already-mentioned tuner module TEA 5777 allows a deviation setting at 10 kHz or 20 kHz. From a starting point, the auxiliary FM receiver 20′ then starts the search in a predetermined search direction, wherein it is possible to transmit corresponding data concerning the starting point and search direction to the auxiliary FM receiver 20′ via the control means 21. In this operating mode, e.g. a capacitor is charged via a constant-current source (not shown in the drawing) and a uniformly rising or falling tuning voltage is generated in this manner for a capacitance diode, which capacitance diode is provided to generate the oscillator frequencies. As soon as an HF signal with a value above the previously defined sensitivity threshold is detected, the search stops, upon which data concerning the detected frequency is transmitted to the control means 21 as the result signal. In this manner, a greatly accelerated transmitter search is realized, since the frequency detection means 20 respond only to strong signals that are sought. In order to find the strongest signal, the procedure may be such that the scanning sensitivity is set to be initially very low and subsequently increased in stages. In this manner, the initial search for the local oscillator frequency of the FM receiver 2 can be carried out in a relatively short time, of the order of one (1) second. When a local oscillator frequency has been established, the auxiliary FM receiver 20′ locks on to this frequency, i.e. the PLL circuit 25 is activated. As a result, it is also ensured that the auxiliary FM receiver 20′ can immediately follow any change in this local oscillator frequency so that the changed, or new, frequency is available with virtually no delay.

Owing to the wired connection means 16, in particular the coaxial connection, between the appliance 1 and the FM receiver 2, it is also achieved that virtually no interference frequencies lie at the connection point 15, but that the frequency spectrum is “clean”, wherein the signal strengths of the HF signal supplied to the frequency detection means 20 are comparable with the signal strength of a typical FM signal received via an antenna. In addition, as mentioned, the bandpass filter means 19 assist in suppressing undesired noise or intermodulation products.

It should be mentioned here that, in addition to taking the form of a passive bandpass filter, the bandpass filter means 19 may also be an adaptive filter with activation by the microprocessor or the control means 21 of the appliance 1. In principle, it is possible to omit the bandpass filter means 19.

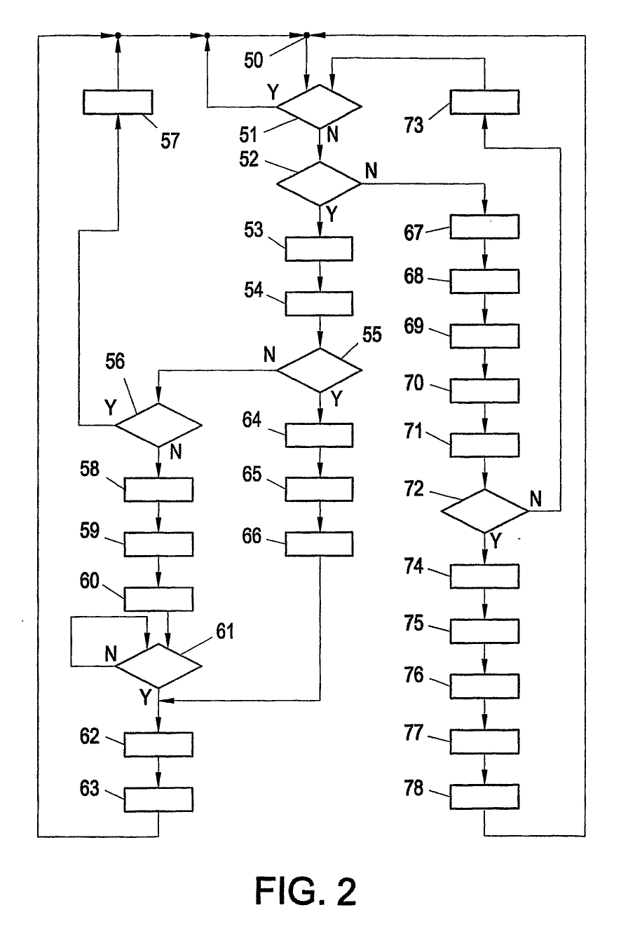

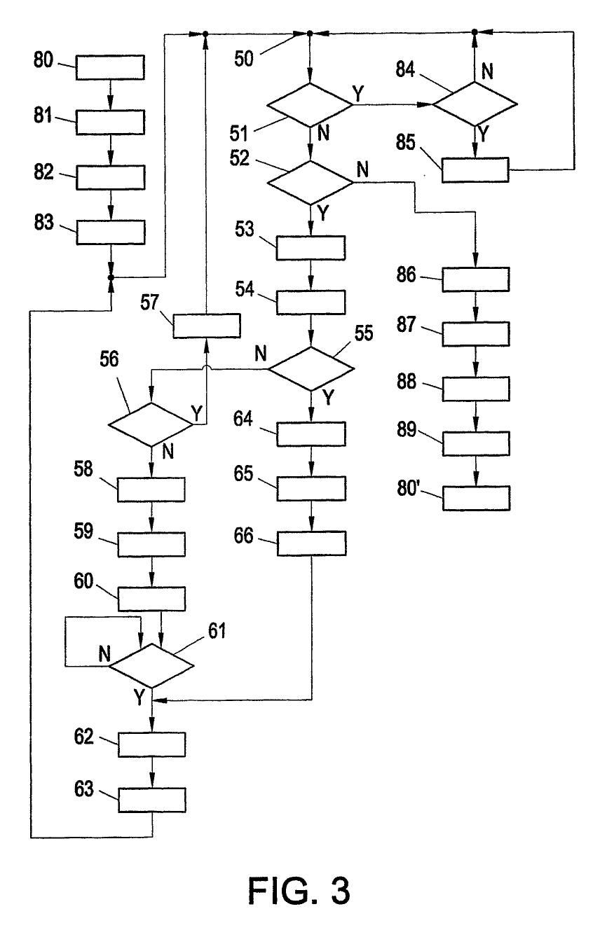

An automatic search may be initiated in the DAB reception means 3 by the detection of certain features, in particular certain change patterns in the local oscillator frequency of the FM receiver 2. This is explained more fully below with reference to FIGS. 2 and 3.

In the present case, a direct assignment of FM channels, or FM frequencies, and DAB channels, or DAB frequencies, is defined in the memory means 28. It may be mentioned that a fixed assignment of a raster of FM channels to preferred, selected DAB channels may be provided, wherein a corresponding channel of the previously set DAB channels is then selected using tuning elements on the FM receiver 2. This is advantageous primarily because, in the case of static systems, not all transmitters can be received from the outset, so a complete “replication” of the DAB channels onto the FM channels and vice versa is not necessary. In this case, in a once-only setting operation when the appliance 1 is put into operation, a special selection of transmitters is made and a corresponding assignment between DAB channels and FM channels is stored in the memory means 28, as explained more fully below with reference to FIGS. 2 and 3.

It is known that the normal FM reception range contains frequencies between 87.5 MHz and 108 MHz with an interval or raster of 50 kHz (in the USA and for portable appliances, the interval is 100 kHz). This leads to 410 (or 205) possible FM frequencies or FM channels.

In the DAB system, there are two frequency bands, band III and the L band, wherein it may be anticipated that many DAB receivers will be restricted to band III, in particular for cost reasons. Band III comprises 38 frequencies in the range between roughly 174 MHz and 240 MHz, specifically the channels or frequencies specified in the following Table 1:

TABLE 1

| | |
|---|---|
| 5A | 174.928 MHz |
| 5B | 176.640 MHz |
| 5C | 178.352 MHz |
| 5D | 180.064 MHz |
| 6A | 181.936 MHz |
| 6B | 183.648 MHz |
| 6C | 185.360 MHz |
| 6D | 187.072 MHz |
| 7A | 188.928 MHz |
| 7B | 190.640 MHz |
| 7C | 192.352 MHz |
| 7D | 194.064 MHz |
| 8A | 195.936 MHz |
| 8B | 197.648 MHz |
| 8C | 199.360 MHz |
| 8D | 201.072 MHz |
| 9A | 202.928 MHz |
| 9B | 204.640 MHz |
| 9C | 206.352 MHz |
| 9D | 208.064 MHz |
| 10A | 209.936 MHz |
| 10B | 211.648 MHz |
| 10C | 213.360 MHz |
| 10D | 215.072 MHz |
| 11A | 216.928 MHz |
| 11B | 218.640 MHz |
| 11C | 220.352 MHz |
| 11D | 222.064 MHz |
| 12A | 223.936 MHz |
| 12B | 225.648 MHz |
| 12C | 227.360 MHz |
| 12D | 229.072 MHz |
| 13A | 230.784 MHz |
| 13B | 232.496 MHz |
| 13C | 234.208 MHz |
| 13D | 235.776 MHz |
| 13D | 237.488 MHz |
| 13D | 239.200 MHz |

The particular feature hereby is that each of the frequencies cited in Table 1 may contain a so-called “ensemble”, wherein groups of up to ten audio transmission channels may be contained in an ensemble. A theoretical quantity of 380 possible transmission channels is obtained in this manner in band III.

As already mentioned, not all possible DAB frequencies will be usable at a particular location for technical reasons, so it is better not to assign the individual FM channels and DAB channels directly to one another in a kind of “1:1 replication”, but rather to provide an adaptive assignment. It may hereby be provided that, when the nearest FM frequency is selected on the FM receiver 2, the DAB reception means 3 do not necessarily move up one stage to the next frequency, but search for and find some other assigned DAB channel. This procedure is extremely flexible and enables the L band to be included in the DAB system in the given case.

When detecting the local oscillator frequency and during the manual or automatic setting of this local oscillator frequency (when searching for particular transmitters), the frequency detection means 20 in conjunction with the control means 21 execute various functions. These functions derive from the routines explained below with reference to FIGS. 2 and 3. One advantageous function hereby is that, in establishing a possible frequency as the local oscillator frequency of the FM receiver 2, the criterion used is whether this local oscillator frequency lies within an acceptance window. In the case of the known auxiliary FM receivers 20′ described, used as frequency detection means 20, this acceptance window may be set, in a manner that is conventional per se, with a limit value of 10 kHz or 20 kHz. If, therefore, the auxiliary FM receiver 20′ locks onto an LOF frequency of the FM receiver 2, the frequency detection means 20 are used to monitor whether this LOF frequency changes over time. Changes within the acceptance window, e.g. by up to 20 kHz, are accepted hereby, and the frequency counter and interface module 27 then comes into operation to provide information as to whether or not the frequency of the FM receiver 2 changes. The counting result of this is transmitted to the control means 21 via a serial interface of the frequency counter and interface module 27.

A further function consists in the fact that, in order to distinguish whether manual tuning or an automatic search is underway at the FM receiver 2, the change pattern of the local oscillator frequency is investigated to distinguish these tuning possibilities. This is accomplished by, for example, causing a feedback signal by a change by one frequency stage (by 50 kHz in the FM band therefore) between the local oscillator frequency and the high frequency previously established by the frequency detection means 20. This feedback signal is transmitted as a separate output signal via the frequency counter and interface module 27 to the control means 21, and examined as to its progression over time, wherein, in the case of an automatic search, the changes in the local oscillator frequency succeed one another comparatively rapidly, whereas changes are relatively slow in the case of manual tuning. A signal of this kind can also be derived by a lowpass filtration of a direct-voltage offset in the left-hand and right-hand output channels.

If the tuning frequency (LOF) of the FM receiver 2 changes rapidly, e.g. by more than one stage in a given time unit and, if applicable, if preset transmitters are selected directly by the user by depression of keys, or if the FM receiver 2 has just been switched on, the local oscillator frequency must be sought, or detected, by the frequency detection means 20. In this case, the control means 21 send a corresponding control signal to the frequency detection means 20, i.e. in particular to the auxiliary FM receiver 20′, via a serial interface, in order to initiate a rapid search, starting from a specified starting point, wherein, as mentioned, a sensitivity threshold is specified for the frequency detection, and wherein the search starts in a specified direction. As soon as the frequency detection means 20 find a frequency corresponding to the conditions, they stop at this frequency and transmit a corresponding message, via the serial interface, to the control means 21.

In a routine shown in FIG. 2, which is implemented using the control means 21 and the frequency detection means 20, the first step after a starting point 50 is, for example, to query at a query field 51 whether the local oscillator frequency lies within the acceptance window, i.e. within a band of ±20 kHz either side of the particular oscillator frequency. If this applies, the momentary state is retained, i.e. a return to the starting point 50 takes place, and the query from query field 51 is repeated cyclically. If the query response is negative, however, it is queried at a query field 52 whether the changed local oscillator frequency lies within one frequency step (i.e. 50 kHz) upwards or downwards. If this applies, the setting of the frequency detection means 20 to the new local oscillator frequency is undertaken at a block 53, after which there is a wait at block 54 for a specified time, e.g. 0.2 seconds. Subsequently, an investigation again takes place at query field 55 as to whether the—new—local oscillator frequency lies within the acceptance window (e.g. ±20 kHz). If this does not apply, it is queried at a further query field 56 whether the local oscillator frequency has changed back to the previous frequency value, but if it applies, the auxiliary FM receiver 20′ is, in turn, set to this “new” local oscillator frequency at block 57 and the routine is started again at the starting point 50.

If, however, it is established at the query field 56 that the local oscillator frequency has in fact changed to a different value (and has not reverted to the old value), the FM modulator means 13 are set in the appliance 1 to the new local oscillator frequency ±2 frequency steps, depending on the direction of the search, (block 58) and the appliance 1 is now in an operating mode for an upwards or downwards search. In accordance with a subsequent block 59, the audio signal path to the FM modulator means 13 is then muted by, for example, the control means 21 (e.g. by the relevant activation of the DAB reception means 3) and, in accordance with a block 60, an upward or downward search is started in the DAB reception means 3. It is hereby constantly queried, in accordance with a query field 61, whether a valid DAB transmission channel has been found, and, if a DAB channel of this kind has been found, the audio signal path to the FM modulation means 13 in the appliance 1 is re-activated in accordance with a block 62. At a block 63, corresponding information based on the FIC and PAD data is then evaluated in the control means 21 and transmitted to the FM modulator means 13 for an RDS modulation. The routine then returns to the starting point 50 in FIG. 2.

If the query at query field 55 reveals that the local oscillator frequency lies within the acceptance window, the audio signal path to the FM modulator means 13 is immediately muted in accordance with a “manual tuning” operating mode at a block 64 in FIG. 2; at a subsequent block 65, the FM modulator means 13 are then set to the new local oscillator frequency. Following this, the nearest possible channel or sub-channel in the DAB reception means 3 is then selected (upwards or downwards, depending on the direction of the change in the local oscillator frequency) at a block 66; it should be noted here that the nearest possible channel or sub-channel may be either within an ensemble, or the first or last sub-channel of an adjacent ensemble, or a DAB channel selected from a Table of channels or sub-channels actually used.

The routine is then continued at the already-mentioned block 62 (activation of the audio signal path to the FM modulator means 13) and at the block 63 (transmission of supplementary information for an RDS modulation in the FM modulator means 13).

If, conversely, the query response is negative at query field 52, where it is investigated whether the local oscillator frequency lies within one frequency step upwards or downwards, i.e. a larger frequency jump exists, a change to a “selection of preset station” operating mode takes place, wherein, at a block 67, the audio signal path to the FM modulator means 13 is muted and then, at a block 68, the FM modulator means 13 are halted. Then, at a block 69, a frequency search in the frequency detection means 20 is initiated. A low sensitivity threshold is preferably used at the start; if no frequency is found in the first pass, the sensitivity threshold is increased for the next one, etc. At a block 70, a frequency is established and the corresponding information acquired, after which, at a block 71, a DAB frequency associated with the local oscillator frequency found, which may be stored in a Table, is sought by the control means 21 via the memory means 28, and read. (As already mentioned, this Assignment Table may be user-specific and contain particular DAB stations for this purpose, which are also accessible via station keys on the FM receiver 2). Part of this searching for the associated DAB frequency is a query at a query field 72 in FIG. 2 as to whether the particular local oscillator frequency is included in the Table. If this is not the case, there is a change to a resetting routine at a block 73, and this is explained in greater detail with reference to FIG. 3.

If, however, the local oscillator frequency can be found in response to the query at query field 72, the tuning of the DAB reception means 3 to the DAB frequency read from the Table is initiated at a block 74 (by the control means 21 via the channel setting input 29), after which, at a block 75, the FM modulator means 13 are reactivated and set to the new local oscillator frequency. Then, at a block 76, the audio signal path to the FM modulation means 13 is reactivated and, at a block 77, a “setting” text can then be reproduced for a short period (e.g. for one and a half second) on the display of the FM receiver 2, specifying a channel or station name, via an RDS modulation in the FM modulator means 13, initiated by the control means 21. Then, at a block 78, in a similar way to block 63, the associated supplementary information concerning the RDS modulation can be added to the composite output signal of the FM modulator means 13. Then, finally, a return is made to the starting point 50 of the routine shown in FIG. 2.

FIG. 3 shows the routine in the case of storage of a new preset DAB station associated with a station key on the FM receiver 2 (by way of supplementing routines as already explained with reference to FIG. 2). In the flowchart shown in FIG. 3, the steps relating to the fields and blocks 51 to 66 correspond to the steps in the corresponding fields and blocks in FIG. 2, so a description of them once again may be dispensed with here, and the explanations above may simply be referred to.

However, FIG. 3 shows a specific routine start 80, wherein, starting at a block 81, the audio signal path to the FM modulator means 13 is muted; the FM modulator means 13 are then activated and set to the new local oscillator frequency—see block 82 in FIG. 3. Then, at a block 83 in FIG. 3, e.g. text data in the form of “Select the DAB station that is to be stored assigned to this station key by tuning using the upwards or downwards search keys” is transmitted to the user on the display of the FM receiver 2, wherein a series of station names is shown sequentially via the RDS modulation of the FM modulator means 13, and the message can be advanced in, for instance, intervals of seconds. It is then switched over to the actual starting point 50, wherein the specific routines are started, starting from the already-explained query field 51. If it is established during the course of this query at query field 51 that the local oscillator frequency lies within the acceptance window, a query is then issued at a query field 84 as to whether the appliance 1 has already been in the loop state defined by the routine for more than eight seconds, in order to ensure a time limit for this operating mode. If eight seconds have not yet elapsed since the start, there is a return to the starting point 50 and the query field 51. If, however, the time limit of eight seconds has already elapsed, the user is asked at a block 85, via a corresponding text on the display of the FM receiver 2, whether a station is to be stored, and, if so, the user is requested to actuate the station key. If desired, a new start can then be made at 80.

If the query at query field 51 reveals that the local oscillator frequency does not lie within the acceptance window, and therefore continuation takes place to the query at query field 52, assuming it is then established at this query that the local oscillator frequency does not lie within one frequency step (50 kHz) upwards or downwards, continuation takes place to a block 86 for a setting-memory operating mode, according to which a frequency search is started in the auxiliary FM receiver 20′, this again starting with a low sensitivity threshold, which is increased for every pass if no frequency is found, as already described with reference to block 69 in FIG. 2.

If a frequency is established, the information associated with this established frequency is determined at block 87, in the same way as at block 70 in FIG. 2, and then, at a block 88, the local oscillator frequency is stored in the Table in the memory means 28 together with the associated momentaneous DAB frequency that has been set. Then, at a block 89, a text message, e.g. the text message “stored”, is reproduced on the display of the FM receiver 2, specifying a station name, via the FM modulator means (RDS modulation), to which end the RDS modulation is again used in the FM modulator means 13, and then a return may be made to the start of the routine in order to select and store a further preset transmitter, which is shown in FIG. 3 with a block 80′, corresponding to block 80.

FIG. 4 shows an alternative entry to the operating mode for defining and storing preset stations, including overwriting a preset station already stored. It is assumed here that a program command to this effect has been transmitted to the control means 21 via the setting means 32; for instance, a separate program key may be provided for this among the setting means 32. At the start of FIG. 4, a query is made at query field 90 as to whether a program command of this type has been entered, e.g. by depression of an associated program key, and, if so, a transfer to block 91 is made for the presetting routine in accordance with FIG. 3, wherein, in particular, the steps in accordance with the blocks 81 to 83, the queries in accordance with the query fields 51 and 52 and the steps 86 to 89 are undertaken. If, however, no program field of this type is established from the query at query field 90, i.e. there is no desire to preset stations, there is a changeover to the main loop in accordance with the routines in FIGS. 2 and 3, wherein, in particular, the routines in accordance with the query fields and blocks 51 to 66 are activated.

Via the control means 21 and the RDS modulation in the FM modulator means 13, the most diverse further supplementary information and messages can also be transmitted to the user and shown on, for example, the display of the FM receiver 2, such as a greeting, a message indicating the end of a tape or a message indicating a changeover to a different tape. This is, of course, only possible if the FM receiver 2 is designed for an RDS system of this kind. In addition, information such as the actual DAB frequency and the name of the DAB station and also of the sub-channel in the ensemble, may be shown if a specific frequency has been selected. These messages may also be coded in the RDS data stream under the designation “station name” for example. Further options comprise the transmission of RDS time information and radiotext information, as available in the DAB data system, inserted in predefined RDS data fields, and the displaying of these on the FM receiver 2.

It should be mentioned that the FM receiver 2 is a receiver for FM signals, so this FM receiver may also be designated an FM signal receiver.

It should also be mentioned that the DAB reception means 3 are reception means for DAB signals, so these DAB reception means may also be designated DAB signal reception means.

1. An appliance (1) for converting DAB signals into FM signals and for transmitting the FM signals to an FM receiver (2), said appliance comprising:
DAB reception means (3), which DAB reception means (3) are equipped with an antenna input (4) and, at an output (10), emit an audio signal derived from a received DAB signal, and
FM modulator means (13) for generating an FM signal modulated with the audio signal, and
transmission means for transmitting the FM signal to the FM receiver (2), and control means (21),
wherein the transmission means are equipped with wired connection means (16), to which wired connection means (16) frequency detection means (20) are connected, which frequency detection means (20) are connected to the control means (21) and arranged to detect the high frequency set in the FM receiver (2), and to generate a result signal representing the detection result and deliver it to the control means (21), and
wherein the control means (21) are connected to a channel setting input (29) of the DAB reception means (3), and
wherein the DAB reception means (3) are designed to be tuned on the basis of the result signal delivered to their channel-setting input (29).

2. An appliance as claimed in claim 1, wherein memory means (28) for storing information concerning the mutual correspondence of DAB channels and FM channels are assigned to the control means (21).

3. An appliance as claimed in claim 1, wherein the frequency detection means (20) are connected to the wired connection means (16) via filter means (19).

4. An appliance as claimed in claim 1, wherein the frequency detection means (20) are equipped with an auxiliary FM receiver (20′) with an automatic transmitter search.

5. An appliance as claimed in claim 4, wherein the auxiliary FM receiver (20′) is rated for a reception frequency range from 98.20 MHz to 118.70 MHz.

6. An appliance as claimed in claim 4, wherein the auxiliary FM receiver (20′) is rated for a reception frequency range from 63.30 MHz to 79.30 MHz.

7. An appliance as claimed in claim 4, wherein the frequency detection means (20) are arranged, together with the control means (21), to recognize high-frequency change patterns in order that manual or automatic transmitter scanning operations undertaken at the FM receiver (2) can be recognized.

8. An appliance as claimed in claim 7, wherein a high-frequency deviation acceptance window is defined in the frequency detection means (20).

9. An appliance as claimed in claim 1, wherein the wired connection means (16) are connected to the antenna input (4) of the DAB reception means (3) via a line (35) containing switching means (36).

10. An appliance as claimed in claim 9, wherein the switching means (36) are equipped with a control input (36′) connected to the control means (21).

11. An appliance as claimed in claim 1, wherein inputting means (32) are assigned to the control means (21).

12. An appliance as claimed in claim 11, wherein the inputting means (32) comprise remote-control means (33).

13. An appliance as claimed in claim 11, wherein the inputting means (32) comprise a connection line (40) to control means of the FM receiver (2).

14. An appliance as claimed in claim 3, wherein the analog audio signal is also applied directly to output sockets (43).

15. An appliance as claimed in claim 1, wherein the FM modulator means (13) are arranged to process supplementary information during the FM modulation.

16. An appliance as claimed in claim 15, wherein the FM modulator means (13) are connected to the control means (21) in order to supply supplementary information.

17. An appliance as claimed in claim 15, wherein the FM modulator means (13) are arranged to process the supplementary information by modulation of a carrier signal in accordance with the RDS method.
